(19) United States
(12) Patent Application Publication
(10) Pub. No.: US 2007/0218834 A1
(43) Pub. Date: Sep. 20, 2007

(54) Method and apparatus for continuous sampling of respondents

(75) Inventors: Guy Yogev, Tel Aviv (IL); Vlad Azarkhin, Petah Tikva (IL); Eyal Barnea, Givatayim (IL)

Correspondence Address: Ms. Ronny Fogel;Brux Software Solutions Ltd., 8 Gordon Street, Givatayim, 53235, omitted

(73) Assignee: Ransys Ltd.

(21) Appl. No.: 11/705,749

(22) Filed: Feb. 14, 2007

Related U.S. Application Data
(60) Provisional application No. 60/775,774, filed on Feb. 23, 2006.

(51) Int. Cl. H04H 9/00

(52) U.S. Cl. 455/2.01

(57) ABSTRACT

A method and system for continuously sampling events with respect to one or more sampling entities, comprising receiving a new event, adding the new event to a current events list, selecting an event to be sampled from the current events list, obtaining feedback data from the selected event, and saving feedback data in a feedback store, wherein said current events list is continuously updated with newly received events, wherein said feedback store is continuously updated with newly received samples feedback, and wherein said continuously updated current events list and feedback store are used by said step of selecting one or more event to be sampled.

### CROSS-REFERENCE TO RELATED PATENT APPLICATIONS

This patent application claims priority from and is related to U.S. Provisional Patent Application Ser. No. 60/775,774, filed Feb. 23, 2006, this U.S. Provisional Patent Application incorporated by reference in its entirety herein.

### FIELD OF THE INVENTION

The present invention deals with methods and systems for collecting feedback and survey responses for ongoing monitoring and evaluation of business processes (e.g. customer service), and particularly with continuous sampling of respondents, based on the collected feedback.

### BACKGROUND OF THE INVENTION

In the past, in the realm of surveys and feedback it was customary to perceive the survey as a snapshot that was valid for a given point in time. Today, more and more surveys are performed continuously over time and are not intended to provide a snapshot, but rather to monitor processes on an ongoing basis. Thanks to ongoing control, we can obtain feedback in real time, identify trends and, in particular, respond immediately to the results, on both a general and an individual basis. For example: today, more than ever before, organizations differ from one another in terms of the quality of service they provide to their customers. For this reason they must collect feedback from their customers on a daily basis, in order for the feedback to represent various activities, various periods and various service providers. Continuous feedback also enables real-time handling of the feedback that is given, i.e. getting back to a dissatisfied customer and continuing handling, mentoring the service rep, streamlining processes and powers and more.

Existing systems and methods use two distinct processes, namely: sampling respondents and collecting answers from them, where the collection is performed once the sampling has been done. Thus, current methods are not suitable for monitoring a continuous flow of events in a dynamic environment.

Because resources devoted to obtaining feedback are limited, optimization must be performed in order for the feedback collected to reflect the most recent situation, and to comply with a long series of rules, constraints and priorities, so that the process wilt provide the organization with maximum relevant information.

A method is therefore needed wherein sampling is performed over time, by means of variable sampling, so that the information obtained is optimal.

### SUMMARY OF THE INVENTION

The present invention attempts to overcome the shortcomings of existing sampling systems and methods, by providing a combined system of dynamic sampling and collection, wherein the sampling process and the feedback collection process are interdependent over time.

According to a first aspect of the present invention, there is provided a method of continuously sampling respondents with respect to one or more sampling entities, comprising the steps of: receiving a new event, adding the new event to a current events list, selecting an event to be sampled from said current events list, sampling the selected event, and saving feedback data from said sampled event in a feedback store, wherein said current events list is continuously updated with newly received events, wherein said feedback store is continuously updated with newly received samples feedback, and wherein said continuously updated current events list and feedback store are used by said step of selecting one or more event to be sampled.

In one embodiment of this aspect, the step of selecting one or more events to be sampled comprises: filtering out events that do not satisfy one or more predefined constraints, prioritizing the remaining events, and selecting the one or more highest priority events, wherein each sampling entity may be assigned a quota of feedbacks within a predefined cycle time.

In a second embodiment of this aspect, the quota is fixed throughout the cycle time.

In a third embodiment of this aspect, the quota is changeable within the cycle time.

In a fourth embodiment of this aspect, the quota change expresses the relation between the number of events that have occurred in a sub-group within the current cycle and the total number of events that have occurred in the current cycle in its parent group.

In a fifth embodiment of this aspect, the step of prioritizing events to be sampled comprises checking whether the quota of the sampling entity to which an event relates is full.

In a sixth embodiment of this aspect, the step of prioritizing events to be sampled comprises calculating the variance of feedback received for a sampling entity within said predefined cycle time and increasing the priority of events related to said sampling entity if the calculated variance is high relative to a predetermined threshold.

In a seventh embodiment of this aspect, the step of prioritizing events to be sampled comprises calculating the frequency of events related to said sampling entity within said time cycle and decreasing the priority of higher-frequency events.

According to a second aspect of the present invention, there is provided a program storage device readable by machine, tangibly embodying a program of instructions executable by the machine to perform method steps of: receiving a new event, adding the new event to a current events list, selecting an event to be sampled from said current events list, sampling the selected event, and saving feedback data from said sampled event in a feedback store, wherein said current events list is continuously updated with newly received events, wherein said feedback store is continuously updated with newly received sample feedbacks, and wherein said continuously updated current events list and feedback store are used by said step of selecting one or more event to be sampled.

According to a third aspect of the present invention, there is provided a system for continuously sampling events with respect to one or more sampling entities, comprising: means for receiving a new event, means for storing the new event in a current events store, means for selecting an event to be sampled from said current events store, means for sampling the selected event, and means for storing feedback data from said sampled event in a feedback store, wherein said current events store is continuously updated with newly received events, wherein said feedback store is continuously updated with newly received samples feedback, and wherein said continuously updated current events store and feedback store are used by said step of selecting one or more event to be sampled.

In one embodiment of this aspect, the means for selecting one or more events to be sampled comprise: means for filtering out events that do not satisfy one or more predefined constraints, means for prioritizing the remaining events, and means for selecting the one or more highest priority events.

In a second embodiment of this aspect, the system additionally comprises means for assigning to each sampling entity a quota of feedbacks within a predefined cycle time.

In a third embodiment of this aspect, the system additionally comprises means for changing said quota within the cycle time.

In a fourth embodiment of this aspect, the means for changing the quota comprise means for calculating the relation between the number of events that have occurred for a sampling entity comprising a sub-group and the number of events that have occurred for its parent group.

In a fifth embodiment of this aspect, the means for prioritizing events to be sampled comprise means for checking whether the quota of the sampling entity to which an event relates is full.

In a sixth embodiment of this aspect, the means for prioritizing events to be sampled comprise means for calculating the variance of feedback received for a sampling entity within said predefined cycle time, and increasing the priority of events related to said sampling entity if the calculated variance is high relative to a predetermined threshold.

In a seventh embodiment of this aspect, the means for prioritizing events to be sampled comprise means for calculating the frequency of events related to said sampling entity within said time cycle and decreasing the priority of higher-frequency events.

### BRIEF DESCRIPTION OF THE DRAWINGS

FIG. 1 is a general flowchart describing the continuous sampling process according to the present invention;

FIG. 2 is a flowchart describing the actual sampling of the chosen sampling event according to the present invention; and

FIG. 3 is an overall system view of the present invention.

### DETAILED DESCRIPTION OF THE INVENTION

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

According to the present invention, the two processes of choosing a sample and getting feedback from the chosen sample are combined, so that the next candidate to be sampled is chosen based on the most updated feedback obtained up to that point in time, and subject to a series of constraints and business rules, up to a completion of a sampling quota defined for the sampling period. This is in contrast with prevailing systems where the two processes are performed sequentially.

The following terms are used throughout the following description:
1. Sampling entity—a factor or subject about which feedback is sought (e.g. a customer service representative or a service given to customer).
2. Hierarchical structure of the sampling entities—each sampling entity belongs to a group that may belong to a parent group which in turn can belong to another. The number of levels in the hierarchy is determined by business considerations. For example: Division, call center, team, service representative; or all the organization's services, service group (in the case of a municipality: Education, Sanitation, Welfare), type of individual service (waste removal, repair of a burst pipe, etc.).
3. Event—e.g. service event that had occurred in the past, potential for sampling or already sampled. For example: phone encounter with a service representative, or problem report. Each event holds encounter details (number, name, type etc.), details of the reference on the customer side, (customer number, name, phone number etc.), details of the reference on the organization side (representative number, name, representative organizational unit number etc.).
4. Respondent—person, who is being asked to give feedback regarding the event he or she was involved in.
5. Sampling cycle—the period of time in which the sampling quota needs to be accomplished (e.g. a week, a month, a quarter). This is a period chosen according to business considerations for periodical reports, analysis and statistics. At the beginning of each sampling cycle all quotas are emptied. The continuous sampling method is designed to spread intelligently throughout the cycle period. The sample cycle is a basic period for analysis, predetermined per sampling entity.
6. Quotas—the number of responses required per sampling entity throughout a single sampling cycle. The quotas can be defined at the level of a sampling entity, or for an interim level group. In the case of sampling groups at the interim level, they can either have a quota of their own or their quota can be calculated as the sum of their sub-groups/entities.

According to one embodiment of the present invention, quotas for each sampling entity, at each level, are predefined per sampling cycle.

According to a preferred embodiment of the present invention, quotas for sampling sub-groups may dynamically change during a sampling cycle, according to on-going analysis of the de-facto distribution of incoming events between the various sub-groups. For example, assume a municipality has three sub-groups to be sampled: Sanitation department, Municipal Taxes department and Parking Control department. According to the changing-quota embodiment, if the Sanitation department gets twice the number of events than the Taxes department during the sampling cycle, the relation between the two departments' quotas will gradually be updated to reflect the respective number of events, resulting in more credible statistical results for the municipality, as a top-level sampling entity. The quotas may be updated at predefined time intervals, or after each batch of predefined number of events, or according to any other suitable criterion.

Another reason for dynamically changing quotas may be connected with the analysis of feedback received, wherein the variance of the feedbacks related to a sampling entity may affect the quota size for that sampling entity, so that the quota size will be increased or decreased if the variance is high or low, respectively.

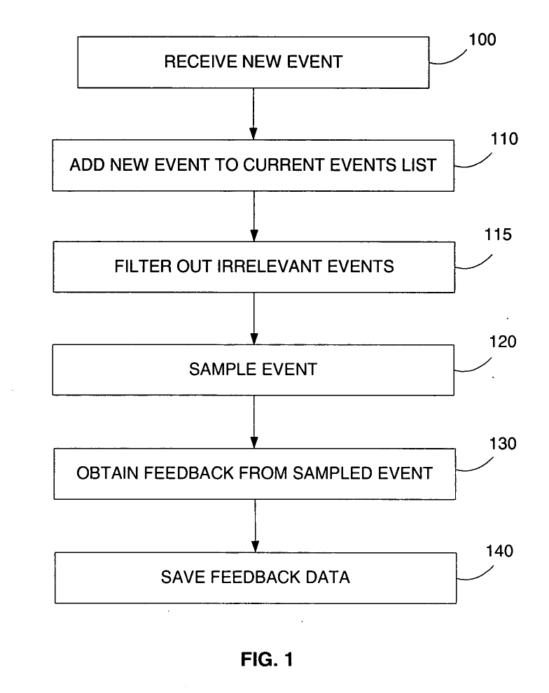

FIG. 1 is a general flowchart describing the continuous sampling process according to the present invention. The process is described as a unitary process of handling a single event, however it will become apparent that the various stages of the process are performed continuously and in parallel, so that real-time changes are immediately taken into consideration and may affect current choices.

In step 100, a new event is received by the system. An event may be any activity to be monitored by the system, such as a customer calling a customer representative. In step 110, the newly received event is added to a Current Events List, preferably stored in a database, on a local or remote computer.

In step 115, events that do not satisfy certain constrains are filtered out. The constraints may be any of the following, or any other suitable constraint:
a. A respondent “cooling off period.” For example: it is not allowed to ask a customer for feedback in case he has given one during the past 60 days.
b. A Basic Sampling Entity “cooling off period”. For example: it is not allowed to ask customers for feedback on a specific service representative, in case feedback regarding the same service representative has been received during the past five days.
c. “Blacklist”—a list of customers who have asked never to be called for feedback purposes
d. Smart handling of a series of events—For example, if a customer has called several times a day on the same subject, only one of the calls in the series will be selected as a call representing the event.
e. The event is not within the currently specified sampling cycle for the relevant sampling entity.

In step 120, the remaining events are considered for choosing a candidate sampling event, in Step 130 the chosen event is sampled, and in step 140 the feedback from the sampled event is saved.

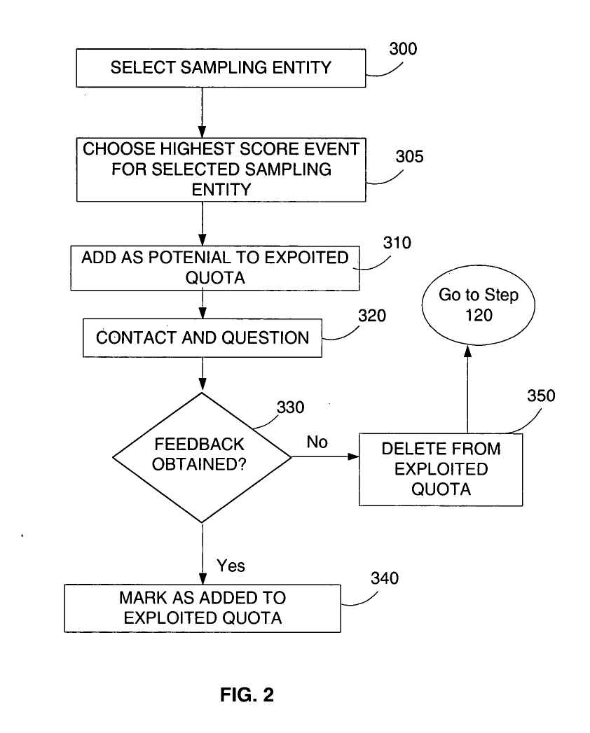

FIG. 2 is a flowchart describing the actual sampling of the chosen sampling event. In step 300, a sampling entity is selected. In step 305, the events for the selected sampling entity are prioritized and the highest score event is selected for sampling, added to the sample count of the relevant sampling entity's quota and marked as “potential” (step 310).

In the process of prioritization, each event is given a score. Typically, only one event wilt be selected (sampled) each time, since for each sampling process the filtering (constrains) and the prioritization may change. Potentially more than one event will be chosen, namely a number of events having the highest scores, thus creating a buffer of sampled events. The reason for choosing more than one event for sampling, is to prevent a situation where there is no selected customer to be interviewed, e.g. when the speed of interviews is higher than the speed of calculation and filtration.

The scoring process for the purpose of prioritization is a complex one, and may be affected by various dynamic parameters, including but not limited to:
a. Reference to quotas. For each sampling entity, the system will examine the percentage of responses that have been received to date relative to the required quota for the cycle. Quotas for the sampling entities at each of the levels of hierarchy can be defined.
b. Reference to importance. A level of importance may be determined for each sampling entity. The importance will be used to calculate the overall score to be used for prioritizing the selection. Importance can be defined for the sampling entities at each of the levels, and then the calculation will be weighted throughout the entire hierarchy. Unlike the reference to quotas, where importance is related to the sampling's rate of progress within each entity, what is involved here is the entity's permanent importance, which stems from the subject that it represents.
c. Frequency of events in the sampling entity. In view of the data history obtained, the system calculates the frequency of events for each sampling entity. A priority is determined according to this calculation, so that the higher the frequency of events for the entity, the lower the priority that they are given. The reason for this is to dwell on and prioritize a rare incident, so that when it does occur, an attempt will be made to sample it before it becomes obsolete or is rejected in view of constraints that might become active at a later stage.
d. Variance of responses for the sampling entity. The variance of the responses that have been received for the sampling entity during the current cycle period will serve as a criterion. The weight that is given is directly related to the variance (low variance-low priority). Where the variance is high, relative to a predetermined threshold, additional sampling is required in order to reduce the sampling error involved. Thus, throughout the entire period, the overall sampling error of the sample as a whole will decrease and the accuracy of the results will increase.

Attention is drawn back to FIG. 2. In step 320 the actual questioning is performed, e.g. by contacting a customer. In step 330 a decision is made as to whether:
a. The questioning has been successful, e.g. customer has been contacted and has supplied feedback;
b. The questioning is being maintained “on hold”, e.g. the line was busy; or
c. The questioning has been unsuccessful, e.g. the customer has not been attained.
If the questioning has been successful (step 340), the sample is added to the quota as “permanent”. If the questioning has been unsuccessful (step 350), the sample is deleted from the quota and the process goes back to step 120 (FIG. 1) to choose a new candidate for sampling.

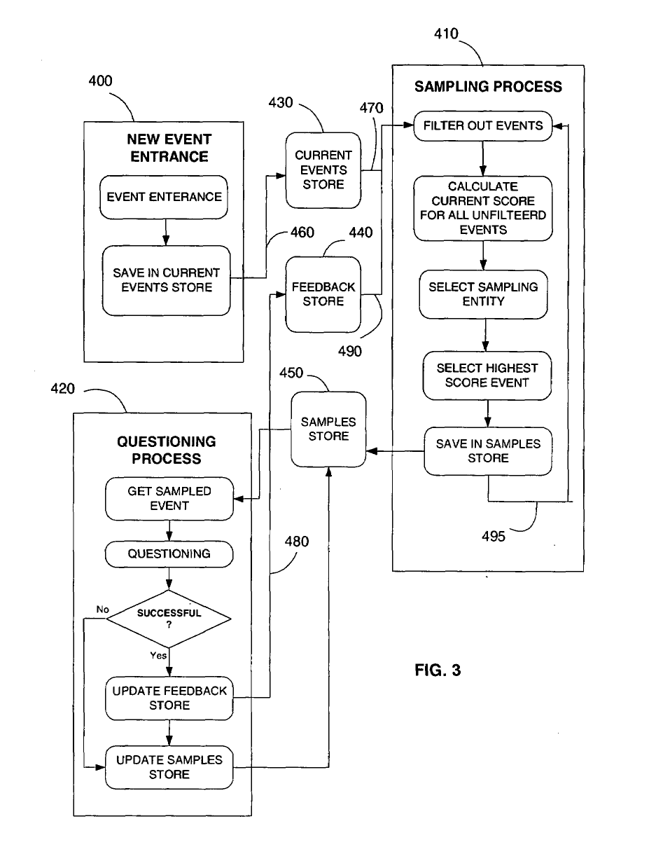

The dynamic real-time updating of the sampling system according to the present invention will be better understood with the overall system view as presented schematically in FIG. 3.

FIG. 3 presents the three main processes according to the present invention: New Event Entrance (400), Sampling Process (410) and Questioning Process (420). Also shown in FIG. 3 are three main storage units: Current Events Store (430), Feedback Store (440) and Samples Store (450). It wilt be appreciated that the separate stores may reside on a single storage device, local or remote, or be distributed in any combination of local and/or remote.

The main steps in each of the processes have been explained and will not be repeated. Attention is drawn to the arrows connecting the various process steps to the three storage units, representing ongoing storing and retrieving of data.

Arrow 460 represents saving a new incoming event in the Current Events Store 430, while arrow 470 shows the inclusion of each new coming event in the score calculation, so as to include the new event in the sample selection process described hereinabove.

Arrow 480 represents saving feedback obtained during questioning in the feedback store 440, while arrow 490 shows the ongoing use of new feedback in the considerations involved in the score calculations described hereinabove.

Arrow 495 represents an ongoing sampling process.

The computer program for performing the method of the present invention may be stored in a computer readable storage medium. This medium may comprise, for example: magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A method of continuously sampling events with respect to one or more sampling entities, comprising the steps of:
receiving a new event;
adding the new event to a current events list;
selecting one or more events to be sampled from said current events list;
obtaining feedback data from the selected event; and
saving said feedback data in a feedback store,
wherein said current events list is continuously updated with newly received events,
wherein said feedback store is continuously updated with newly received samples feedback, and
wherein said continuously updated current events list and feedback store are used by said step of selecting one or more event to be sampled.

2. The method according to claim 1, wherein said step of selecting one or more events to be sampled comprises:
filtering out events that do not satisfy one or more predefined constraints;
prioritizing the remaining events; and
selecting the one or more highest priority events.

3. The method according to claim 2, wherein each sampling entity is assigned a quota of feedbacks within a predefined cycle time.

4. The method according to claim 3, wherein said quota is fixed throughout the cycle time.

5. The method according to claim 3, wherein said quota is changeable within the cycle time.

6. The method according to claim 5, wherein said sampling entity comprises a sub-group of a parent sampling entity, and wherein the quota change expresses the relation between the number of events received for said sub-group and the number of events received for the parent, within the cycle time.

7. The method according to claim 5, wherein the quota change results from a calculation of said feedbacks variance.

8. The method according to claim 3, wherein said step of prioritizing events to be sampled comprises checking whether the quota of the sampling entity to which an event relates is full.

9. The method according to claim 3, wherein said step of prioritizing events to be sampled comprises calculating the variance of feedback received for a sampling entity within said predefined cycle time and increasing the priority of events related to said sampling entity if the calculated variance is high relative to a predetermined threshold.

10. The method according to claim 3, wherein said step of prioritizing events to be sampled comprises calculating the frequency of events related to said sampling entity, within said time cycle and decreasing the priority of higher-frequency events.

11. A program storage device readable by machine, tangibly embodying a program of instructions executable by the machine to perform method steps of:
receiving a new event;
adding the new event to a current events list;
selecting one or more events to be sampled from said current events list;
obtaining feedback data from the selected event; and
saving said feedback data in a feedback store,
wherein said current events list is continuously updated with newly received events,
wherein said feedback store is continuously updated with newly received samples feedback, and
wherein said continuously updated current events list and feedback store are used by said step of selecting one or more event to be sampled.

12. A system for continuously sampling events with respect to one or more sampling entities, comprising:
means for receiving a new event;
means for storing the new event in a current events store;
means for selecting one or more events to be sampled from said current events store;
means for obtaining feedback data from the selected event; and
means for storing said feedback data in a feedback store,
wherein said current events store is continuously updated with newly received events,
wherein said feedback store is continuously updated with newly received samples feedback, and
wherein said continuously updated current events store and feedback store are used by said means for selecting one or more events to be sampled.

13. The system according to claim 12, wherein said means for selecting one or more events to be sampled comprise:
means for filtering out events that do not satisfy one or more predefined constraints;
means for prioritizing the remaining events; and
means for selecting the one or more highest priority events.

14. The system according to claim 12, additionally comprising means for assigning to each sampling entity a quota of feedbacks within a predefined cycle time.

15. The system according to claim 14, additionally comprising means for changing said quota within the cycle time.

16. The system according to claim 15, wherein said means for changing the quota comprise means for calculating the relation between the number of events received for a sampling entity comprising a sub-group and the number of events received for a parent of said sub-group, within the cycle time.

17. The system according to claim 13, wherein said means for prioritizing events to be sampled comprise means for checking whether the quota of the sampling entity to which an event relates is full.

18. The system according to claim 14, wherein said means for prioritizing events to be sampled comprise means for calculating the variance of feedback received for a sampling entity within said predefined cycle time and increasing the priority of events related to said sampling entity if the calculated variance is high relative to a predetermined threshold.

19. The system according to claim 14, wherein said means for prioritizing events to be sampled comprise means for calculating the frequency of events related to said sampling entity, within said time cycle and decreasing the priority of higher-frequency events.

20. A system for continuously sampling events with respect to one or more sampling entities, comprising:
input means for receiving new events;
event storage means connected with said input means, for storing said new events;
sampling means connected with said event storage means, for continuously sampling events from an updated events storage;
sample storage means connected with said sampling means, for storing said sampled events;
feedback obtaining means connected with said sample storage means, for updating said samples store with feedback status; and
feedback storage means connected with said feedback obtaining means and with said sampling means, for continuously storing feedback obtained by said feedback obtaining means and for continuously affecting the operation of said sampling means.
